(19) United States
(12) Patent Application Publication
(10) Pub. No.: US 2003/0139932 A1
(43) Pub. Date: Jul. 24, 2003

(54) Control apparatus

(76) Inventors: Yuan Shao, Berkshire (GB); Uwe Helmut Jost, Berkshire (GB)

Correspondence Address: FITZPATRICK CELLA HARPER & SCINTO, 30 ROCKEFELLER PLAZA, NEW YORK, NY, 10112, US

(21) Appl. No.: 10/321,448

(22) Filed: Dec. 18, 2002

(30) Foreign Application Priority Data
Dec. 20, 2001 (GB) 0130493.0

(51) Int. Cl. G10L 21/00

(52) U.S. Cl. 704/275

(57) ABSTRACT

A control apparatus (2) has a user interface manager (21;22) having at least one interface module (215,214,213,216,211;221,222,223,224) adapted to receive data for a corresponding user interface mode. A dialogue manager (201) associated with a dialogue interpreter (202) is arrange to conduct a dialogue with the user in accordance with mark-up language document files supplied to the dialogue conductor. In an embodiment, the control apparatus determines any user interface mode or modes specified by a received mark-up language document, determines whether the user interface manager has an interface module for the specified user interface mode or modes and, if not, obtains an interface module for that interface mode. In another embodiment, the mark-up language document files supplied to the user interface manager specify a type and/or accuracy or confidence level for the interface mode and the control apparatus selects the interface module or modules to be used on the basis of this information. In another embodiment, the control apparatus may be configured to treat an event as an input.

This invention relates to control apparatus for enabling a user to communicate with processor-controlled apparatus using a user input device.

Conventionally, user input devices for processor-controlled apparatus such as computing apparatus consist of a keyboard and possibly also a pointing device such as a mouse. These enable the user to input commands and data in response to which the computing apparatus may display information to the user. The computing apparatus may respond to the input of data by displaying to the user the text input by the user and may respond to the input of a command by carrying out an action and displaying the result of the carrying out of that action to the user, in response to which the user may input further data and/or commands using the keyboard and/or the pointing device. These user input devices therefore enable the user to conduct a dialogue with the computing apparatus to enable the action required by the user to be completed by the computing apparatus. A user may conduct a similar dialogue with other types of processor-controlled apparatus such as an item of office equipment such as a photocopier or an item of home equipment such as a VCR. In these cases, the dialogue generally consists of the user entering commands and/or data using keys on a control panel, in response to which the item of equipment may display information to the user on a display and may also carry out an action, for example produce a photocopy in the case of a photocopier. There is increasing interest in enabling users to conduct such dialogues by inputting commands and/or data using speech and also in providing processor-controlled apparatus that can output speech commands and/or data so that the option of a fully spoken dialogue is available. The use of speech as an input or output mode is, however, not always the most convenient or appropriate way of conducting such a dialogue. Thus, for example, where the control apparatus is configured to display information to the user and the user needs to select a displayed object or icon, then it is generally more convenient for the user to select that object or icon using a pointing device. Similarly, where the dialogue requires the user to input a long string of numbers (for example a credit card number in the case of on-line shopping) then the most convenient way for the user to input that number may be by using a key input mode rather than a speech input mode. Furthermore, different users may find different input modes (input “modalities”) more convenient. In addition, using, for example, a display output mode rather than a speech output mode may be more convenient for the user, especially in these circumstances where the processor-controlled apparatus is providing the user with a lot of information at the same time or with different selectable options.

There is therefore a need to provide control apparatus that facilitates the use by a user of a number of different input and/or output modalities.

In an embodiment, the present invention provides control apparatus for enabling a user to communicate with a processor-controlled apparatus using user interface means having at least two different user modes, the apparatus comprising: user interface management means having a number of interface modules each adapted to receive data using a corresponding one of the user modes; and dialogue conducting means for conducting a dialogue with the user in accordance with mark-up language document files, the apparatus being operable to determine from a mark-up language document file any user interface mode or modes specified by that mark-up language document file and to obtain an interface module for that mode when the user interface management means does not already have an interface module for that mode.

Control apparatus in accordance with this embodiment enables a designer or developer of a mark-up language document file to specify the modes or modalities that are to be available for that mark-up language document file without having to know in advance whether or not the control apparatus that will be used by the user has the required interface module. This gives the designer or developer much more freedom in determining the modalities that are to be available for a mark-up language document file and may allow the designer to specify a modality designed specifically for use with an application of which the mark-up language document file forms a part.

The control apparatus may be arranged to download an interface module via a network, for example from a source or site controlled by the designer or developer of the mark-up language document file, enabling them to have control over the interface module allowing them to ensure that it is compatible with the mark-up language document file.

In an embodiment, the present invention provides control apparatus for enabling a user to communicate with a processor-controlled apparatus using user interface means having at least two different user modes, the apparatus comprising: user interface management means for receiving data input by the user using a corresponding one of the user modes each having at least one attribute; and dialogue conducting means for conducting a dialogue with the user in accordance with mark-up language document files, the apparatus being arranged to determine any user attribute specified by a mark-up language document file and to select the mode or modes having that attribute.

Control apparatus in accordance with this embodiment enables a designer or developer of a mark-up language document file to specify the attribute or attributes required of a mode or modality rather than the actual mode or modality. This means that the designer can simply concern himself with the type of information, for example position information, text and so on and/or the precision or accuracy required for that information without having to know the modes available to the user. For example, if the designer specifies input of position information of a particular accuracy then the user can use any input mode providing the required accuracy. This means that the designer can concentrate on the type of information required to be supplied by the user and not have to worry about the precise specification of the input devices available to the user.

An embodiment of the present invention provides control apparatus for enabling a user to communicate with a processor-controlled apparatus using user input means having at least one user input mode, the apparatus comprising: user interface management means adapted to receive data input by the user using the user input modes; and dialogue conducting means for conducting a dialogue with the user in accordance with mark-up language document files, the apparatus being operable to treat an event occurring within the apparatus or apparatus coupled thereto as an input event where the mark-up language document file defines the event type as an input mode. This enables control apparatus in accordance with this embodiment to treat an event as an input so that the occurrence of the event does not, as it would if treated by the control apparatus as an event, cause an interruption in the dialogue with the user.

Embodiments of the present invention will now be described, by way of example, with reference to the accompanying drawings, in which:

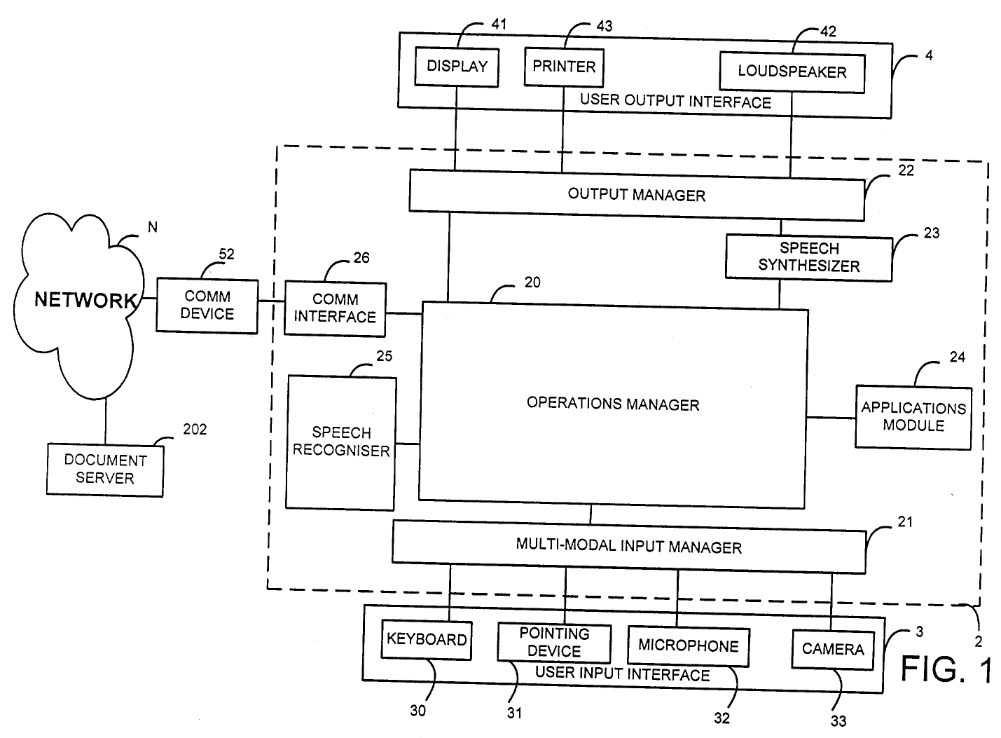

FIG. 1 shows a functional block diagram of processor-controlled apparatus including control apparatus embodying the present invention;

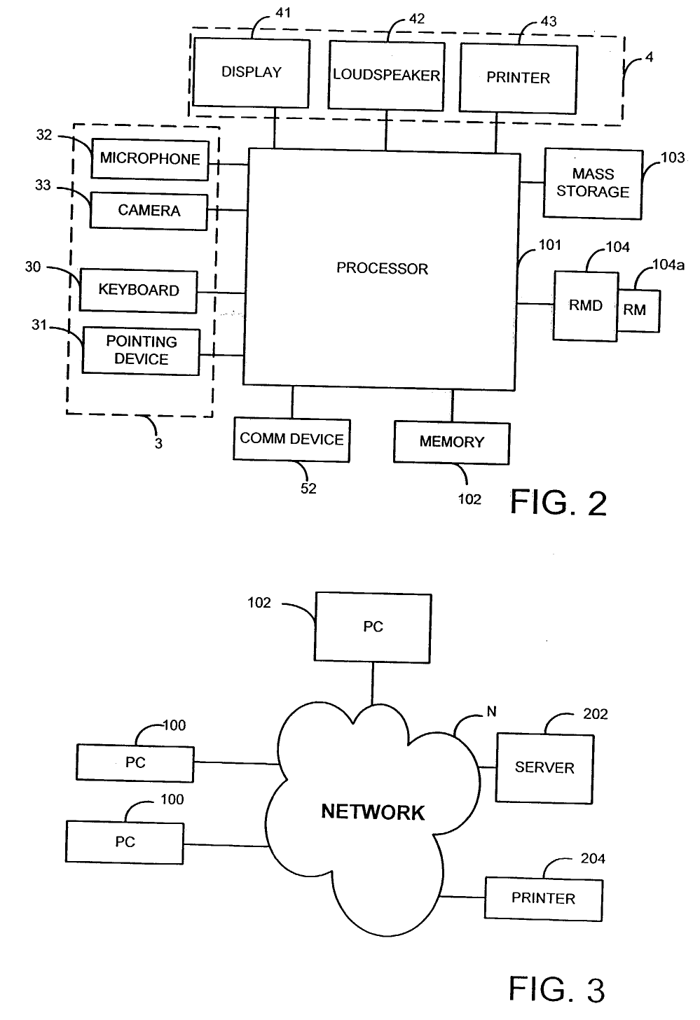

FIG. 2 shows a functional block diagram of computer apparatus that, when programmed, can provide the control apparatus shown in FIG. 1;

FIG. 3 shows a functional block diagram of a network system embodying the present invention;

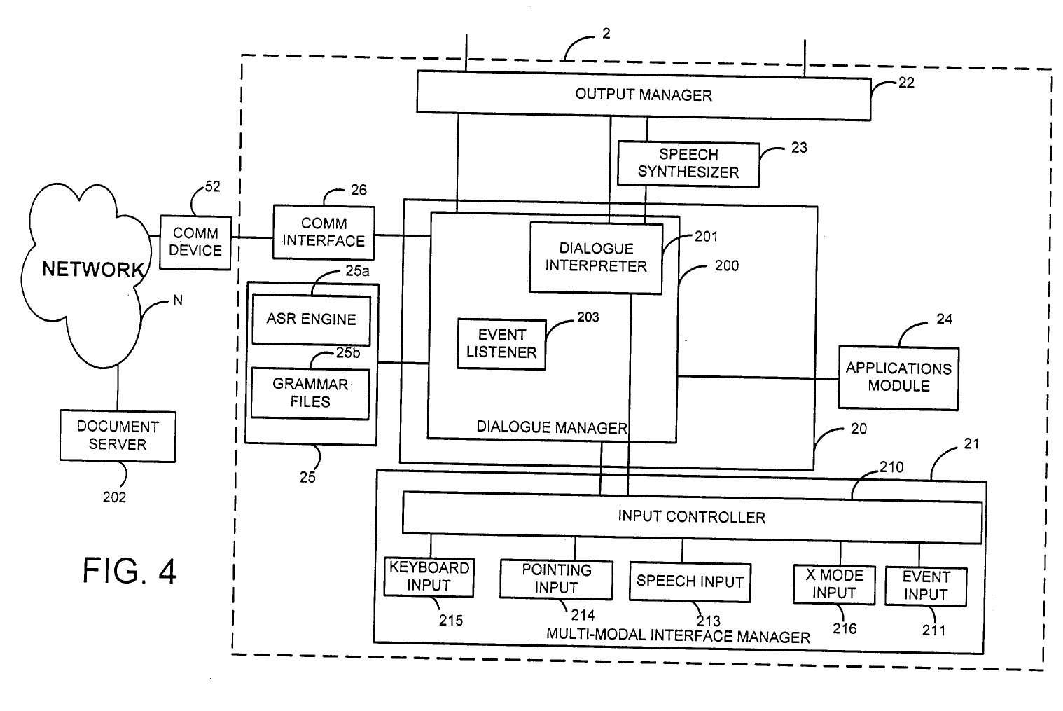

FIG. 4 shows a more detailed functional block diagram of the control apparatus shown in FIG. 1;

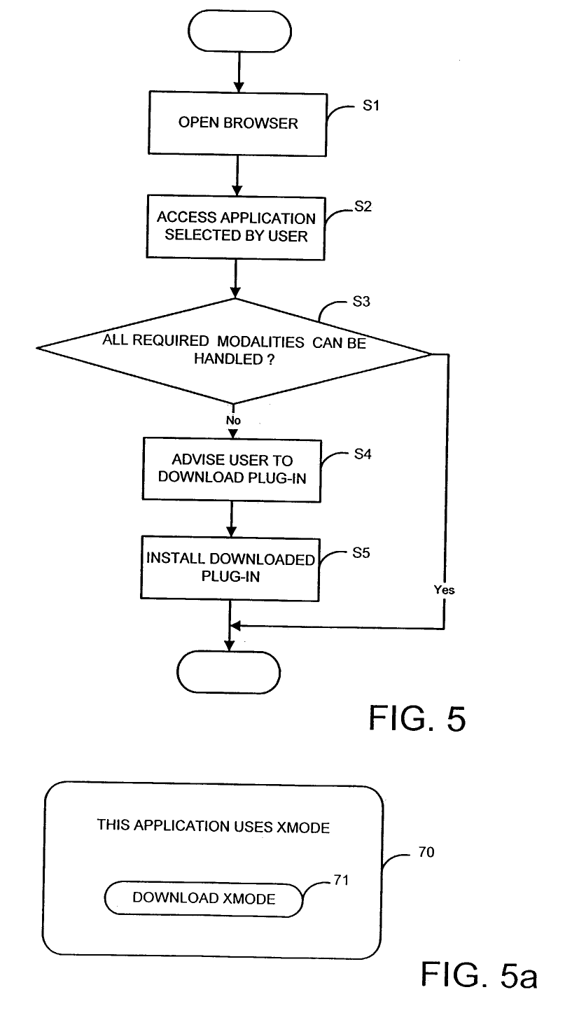

FIG. 5 shows a flow chart illustrating steps carried out by the control apparatus to install a new modality plug-in;

FIG. 5a shows a display screen that may be displayed to a user;

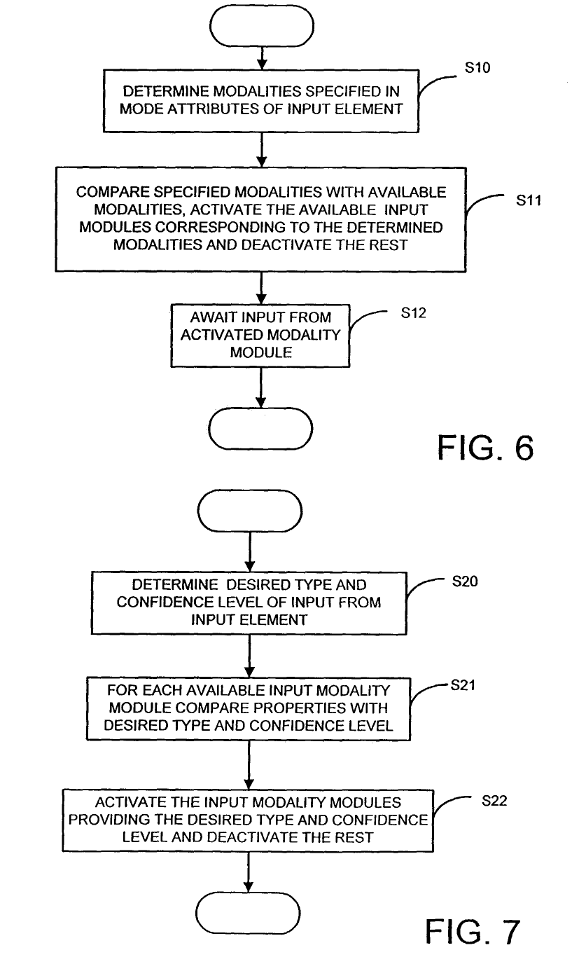

FIG. 6 shows a flow chart illustrating steps carried out by the control apparatus to select certain input modality modules;

FIG. 7 shows a flow chart illustrating steps carried out by the control apparatus to enable receipt of certain types of modality input; and

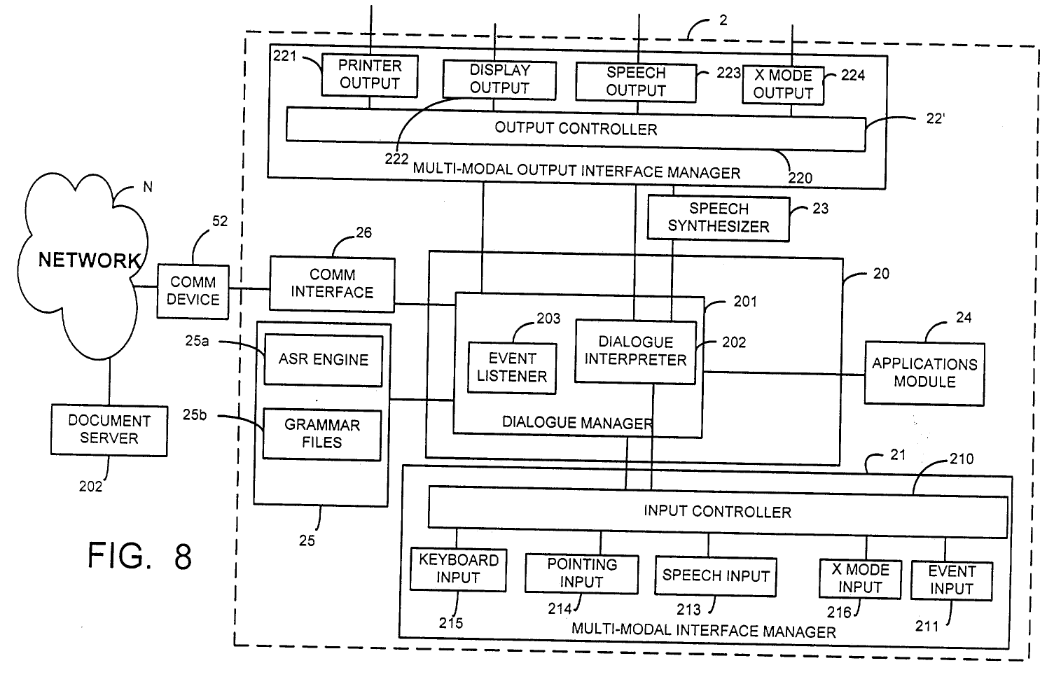

FIG. 8 shows a functional block diagram similar to FIG. 4 of another example of a control apparatus.

Referring now to the drawings, FIG. 1 shows a functional block diagram of processor-controlled apparatus 1 embodying the present invention. As shown in FIG. 1, the processor-controlled apparatus comprises a control apparatus 2 coupled to a user input interface 3 for enabling a user to input data and commands to the controller 2. The user input interface 3 consists of a number of different input devices providing different modalities or modes of user input. In the example shown, the user input devices include a keyboard or key pad 30, a pointing device 31, a microphone 32 and a camera 33. The control apparatus 2 is also coupled to a user output interface 4 consisting of a number of different output devices that enable the control apparatus 2 to provide the user with information and/or prompts. In this example, the user output interface 4 includes a display 41 such as an LCD or CRT display, a loudspeaker 42 and a printer 43. The control apparatus 2 is also coupled to a communication device 52 for coupling the processor-controlled apparatus 1 to a network N.

The control apparatus 2 has an operations manager 20 that controls overall operation of the control apparatus 2. The operations manager 20 is coupled to a multi-modal input manager 21 that is configured to receive different modality inputs from the different modality input devices 31 to 33 making up the user input interface 3 and to provide from the different modality inputs commands and data that can be processed by the operations manager 20. The operations manager 20 is also coupled to an output manager 22 that, under the control of the operations manager 20, supplies data and instructions to the user output interface devices, in this case the display 41 and loudspeaker 42 and possibly also the printer. The output manager 22 also receives input from a speech synthesiser 23 that, under the control of the operations manager 20, converts text data to speech data in known manner to enable the control apparatus 2 to communicate verbally with the user.

The operations manager 20 is also coupled to an applications module 24 that stores applications executable by the operations manager and to a speech recogniser 25 for enabling speech data input via the microphone 32 to the multi-modal input manager 21 to be converted into data understandable by the operations manager 20. The control apparatus 2 may be coupled via the communication device (COMM DEVICE) 52 and the network N to a document server 200.

FIG. 2 shows a block diagram of a computer apparatus 100 that may be used to provide the processor-controlled apparatus 1. The computer apparatus 100 has a processor unit 101 with associated memory 102 (ROM and/or RAM), a mass storage device 103 such as a hard disk drive and a removable medium drive 104 for receiving a removable medium 104a such as a floppy disk, CD ROM, DVD and so on. The processor unit 101 is coupled via appropriate interfaces (not shown) to the user input interface devices (in this case the keyboard 30, pointing device 31, usually a mouse or possibly a digitizing tablet, microphone 32 and camera 33) and to the user output interface devices (in this case the display 41, loudspeaker 42, and the printer 43) and to the communication device 52. The processor unit 101 is configured or programmed by program instructions and/or data to provide the processor-controlled apparatus 1 shown in FIG. 1. The program instructions and/or data are supplied to the processor unit 101 in at least one of the following ways:

1. Pre-stored in the mass storage device 103 or in a non-volatile (ROM) portion of the memory 102;

2. Downloaded from a removable medium 104a; and

3. As a signal S supplied via the communication device 52 from another computing apparatus.

As shown in FIG. 3, the computing apparatus (PC) 100 shown in FIG. 2 is coupled via the communication device 52 to a server 202 and to other computing apparatus (PC) 100 and possibly also to a number of network peripheral devices 204 such as printers over the network N. The network may comprise at least one of a local area network or a wide area network and a connection to the worldwide web or Internet and/or an Intranet. Where connection to the worldwide web or Internet is provided, then the communication device 52 will generally be a MODEM whereas where the network is a local area network or wide area network, then the communication device 52 may be a network card. Of course, both may be provided.

In this example, the control apparatus is configured to operate in accordance with the JAVA (TM) operating platform and to enable a web type browser user interface to be displayed on the display while the server 202 is configured to provide multi-modal mark-up language documents to the computing apparatus 1 over the network N on request from the computing apparatus.

FIG. 4 shows a functional block diagram illustrating the control apparatus 2 shown in FIG. 1 in greater detail. As shown, the control apparatus 2 has a dialogue manager 200 which provides overall control functions and coordinates the operation of other functional components of the control apparatus 2.

The dialogue manager 200 includes or is associated with a dialogue interpreter 201. The dialogue interpreter 201 communicates (over the network N via the communications interface 26 and the communications device 52) with the document server 202 which provides mark-up language document or dialogue files to the dialogue interpreter 201. The dialogue interpreter 201 interprets and executes the dialogue files to enable a dialogue to be conducted with the user. The dialogue manager 200 and dialogue interpreter 201 are coupled to the multi-modal interface manager 21 and to the output manager 22 (directly and via the speech synthesiser 23).

The dialogue manager 200 communicates with the device operating systems of peripheral devices such as the printer 43 by means of, for each peripheral device, a device object that enables instructions to be sent to that device and details of events to be received from that device. The device object may be pre-stored by the control apparatus 2 or may, more likely, be downloaded from the device itself when that device is coupled to the control apparatus via the output manager (in the case of the printer 43) or via the network N (in the case of the printer 202 shown in FIG. 3).

The dialogue manager 200 also communicates with the speech recogniser 25 which comprises an automatic speech recognition (ASR) engine 25a and a grammar file store 25b storing grammar files for use by the ASR engine 25a. The grammar file store may also store grammar files for other modalities. Any known form of ASR engine may be used. Examples are the speech recognition engines produced by Nuance, Lernout and Hauspie, by IBM under the trade name VIAVOICE and by Dragon Systems Inc under the trade name “DRAGON NATURALLY SPEAKING”.

In this embodiment, the dialogue files stored by the document server 202 are written in a multi-modal mark-up language (MMML) that is based on VoiceXML which is itself based on the worldwide web consortiums industry standard extensible mark-up language (XML) adapted for interfacing to speech and telephony resources. VoiceXML is promoted by the VoiceXML forum and by the VoiceXML working group part of W3C. The specification for VoiceXML can be found at, for example, HTTP://www.voicexml.org and at HTTP://www.w3.org.

To facilitate the comparison with the terminology of the VoiceXML specification it should be noted that the dialogue manager 200 is analogous to the VoiceXML interpreter context while the dialogue interpreter 201 is analogous to the VoiceXML interpreter, the document server 202 is of course a document server and the functional components of the control apparatus 2 relating the user interface are, in this case, the multi-modal input manager 21 and the output manager 22.

The document server 202 processes requests from the dialogue interpreter 201 and, in reply, provides mark-up language document files (dialogue files) which are processed by the dialogue interpreter 201. The dialogue manager 200 may monitor the user inputs supplied via the multi-modal input manager 21 in parallel with the dialogue interpreter 201. For example, the dialogue manager 200 may register event listeners that listen for particular events such as inputs from the multi-modal input manager 21 representing a specialist escape command that takes the user to a high level personal assistant or that alters user preferences like volume or text to speech characteristics. As shown in FIG. 4, when a peripheral device such as the printer 51 is instructed by the control apparatus 2 to carry out a function, task or process specified by a user, the dialogue manager 200 may also register an event listener (for example event listener 203 in FIG. 4) associated with the device object for a peripheral device and which listens for events received from that device such as, for example, error messages indicating that the device cannot perform the requested task or function for some reason.

The dialogue manager 200 is responsible for detecting input from the multi-modal input manager 21, acquiring the initial mark-up language document file from the document server 202 and controlling, via the output manager 22, the response to the user's input. The dialogue interpreter 201 is responsible for conducting the dialogue with the user after the initial acknowledgement.

The mark-up language document files (also referred to herein as “documents”) provided by the document server 202 are, like VoiceXML documents, primarily composed of top-level elements called dialogues and there are two types of dialogues, forms and menus.

The dialogue interpreter 201 is arranged to begin execution of a document at the first dialogue by default. As each dialogue executes, it determines the next dialogue.

The documents consist of forms which contain sets of form items. Form items are divided into field items which define the form, field item variables and control items that help control the gathering of the form fields. The dialogue interpreter 201 interprets the forms using a form interpretation algorithm (FIA) which has a main loop that selects and visits a form item as described in greater detail in the VoiceXML specification.

Once, as set out above, the dialogue manager 200 has acknowledged a user input, then the dialogue manager 200 uses the field interpretation algorithm to access the first field item of the first document to provide an acknowledgment to the user and to prompt the user to respond. The dialogue manager 200 then waits for a response from the user. When a response is received via the multi-modal input manager 21, the dialogue manager 200 will, if the input is a voice input, access the ASR engine 25a and the grammar files in the grammar file store 25b associated with the field item and cause the ASR engine 25a to perform speech recognition processing on the received speech file. Upon receipt of the results of the speech recognition processing or upon direct receipt of the input from the multi-modal input manager 21 where the input from the user is a non-spoken input, the dialogue manager 200 causes the dialogue interpreter 201 to obtain from the document server 202 the document associated with the received user input. The dialogue interpreter 201 then causes the dialogue manager 200 to take the appropriate action. This action may consist of the dialogue interpreter 201 causing the output manager to cause the appropriate one of the user output devices (for example, in this case one of the display 41 and loudspeaker 42) to provide a further prompt to the user requesting further information or may cause a screen displayed by the display 41 to change (for example by opening a window or dropping down a drop-down menu or by displaying a different page of a web application) and/or may cause a document to be printed by the printer 51 or communication to be established via the communication device 52 over the network N for example.

As shown in FIG. 4, the multi-modal input manager 21 has a number of input modality modules, one for each possible input modalities. The input modality modules are under the control of an input controller 210 that communications with the dialogue manager 200. As shown in FIG. 4, the multi-modal input manager 21 has a speech input module 213 that is arranged to receive speech data from the microphone 32, a pointing device input module 214 that is arranged to received data from the pointing device 31, a keyboard input module 215 that is arranged to receive keystroke data from the keyboard 30. As will be explained below, the multi-modal input manager may also have an event input module 211 and an X input module 216.

The control apparatus 20 is configured to enable it to handle inputs of unknown modality, that is inputs from modalities that are not consistent with the in-built modules. This is facilitated by providing within the multi-modal mark-up language the facility for the applications developer to specify any desired input modalities so that the application developer's initial multi-modal mark-up language document file of an application defines the input modalities for the application, for example that document may contain:

<input mode=“Speech, Xmode”>

. . .

</input>

Where the input mode tag identifies the modalities specified by the applications developer (in this case speech and Xmode) for this particular document and the ellipsis indicate that content has been omitted. This content may include prompts to be supplied to the user and the grammars to be used, for example the grammars to be used by the speech recogniser 25, when the speech mode is to be used.

As mentioned above, in this embodiment the computing apparatus is operating in accordance with the JAVA platform and the modality input modules are implemented as handler classes each of which can implement a public mode interface for example MODEINTERFACE.JAVA, one example of which is:

public interface ModeInterface {

ModeProperty queryProperty( );
void enable( );
void disable( );
setGrammar (ModeGrammarInterface grammar);

// for notifying input results
addResultListener(InputListenerInterface rli);

The applications developer wishing to make use of a non-standard modality will include within the application either a handler for handling that modality or an address from which the required handler can be downloaded. This handler will, like the built-in handlers, implement a public mode interface so that the input controller 210 can communicate with the handler although the input controller 210 has no information about this particular modality. Thus, the application developer can design the input modality module to receive and process the appropriate input modality data without any knowledge of the processor-controlled apparatus software or hardware, all that is required is that the applications developer ensure that the input modality module implements a public mode interface accessible by the input controller 210.

FIG. 5 shows a flow chart for illustrating steps carried out by the control apparatus 2. Thus, at step S1, the operations manager 20 receives via the multi-modal input manager 21 user input from one of the predefined modalities, for example speech commands inputs using the microphone 32, keystroke commands input using the keyboard 30 and/or commands input using the pointing device 31. In this example, these instructions instruct the operations manager 20 to couple the processor-controlled apparatus 1 to the network such as the Internet via the communications device 52 and to open a browser, causing the output manager 22 to supply to the display 41 a web page provided by an Internet service provider, for example server 200 in FIG. 3. The user may then at step S2 access a particular application written using the multi-modal mark-up language. Generally, the application itself will be stored at the document server 2 which will provide document or dialogue files to the dialogue interpreter 201 on request. As another possibility, the application may be stored in the applications module 24. In this case, the applications module will act as the document server supplying document or dialogue files to the dialogue interpreter on request.

At step S3, the operations manager 20 determines from a first document of the application the modalities specified by that document and checks with the multi-modal input manager 21 if the multi-modal input manager has built in input modules capable of processing all of these modalities, that is if the multi-modal input manager can handle all of the specified modalities. If the answer at step S3 is NO then, at step S4, the dialogue interpreter 21 causes the output manager 22 to provide to the user a message indicating that they need to download a modality plug-in in order to make best use of the application. In this case, the operations manager 20 and the output manager 22 cause the display 41 to display a display screen requesting the user to download the X-mode modality module. FIG. 5a shows an example of a screen 70 that may be displayed to the user. In this case, when the user selects the button “download Xmode” 70 using the pointing device 31, the operations manager 20 causes the communications device 52 to supply a message over the network N to the server 200 requesting connection to the address associated with the “download Xmode” button 71 and, once communication with that address is established, to download the Xmode input modality module from that address in known manner and to install that input modality module as Xmode input modality module 216 shown in FIG. 4 so that the Xmode input modality module can be executed as and when required. As an example, the Xmode input modality module 216 may be a gaze input modality module that is configured to receive video data from the camera 33 and to extract from this information data indicating the part of the screen to which the users gaze is directed so that the gaze information can be used in a manner analogous to data input using the pointing device. As another possibility especially if the control apparatus is a public access control apparatus and not personal to the user, the dialogue manager may cause the received plug-in to be downloaded automatically, that is step S4 will be omitted and screen 70 will not be displayed.

Each of the input modality modules defines the corresponding modality and may also include attribute-data specifying the type or types of the modality and a precision or confidence level for those types. For example, the pointing device input modality module may define as its types, “position” and “selection” that is input types that define a requirement for data that represents a position or a selection, such as a mouse click and may define the precision with which the pointing device can specify these as “high” while the keyboard input modality module and the speech input modality module may both have attribute data specifying a modality type of “text” while the keyboard input modality module may specify that text input must meet the highest possible confidence level for “text”, a level that is known as “certain” while the speech input modality module may specify that the confidence is not “certain” or is “low”, for example where “low” is the lowest possible confidence level.

FIG. 6 shows steps subsequently carried out by the input manager 21. Thus, when the input manager 21 receives a multi-modal mark-up language document input element from the operations manager 20, then at step S10, the input controller 210 determines the modality mode or modes specified in the input element and at step S11 compares the specified modalities with the input modalities available to the multi-modal input manager, activates the input modality modules providing the specified modalities and deactivates the rest. Then at step S12, the input manager awaits input from an activated modality module.

The code that may be implemented by the input controller 210 to carry out steps S10 and S11 may be, for example:

For each of the modes specified within the mode
attributes of the input element {

ModeInterface modality= getMode (modeName);
if (modality==null) {
if (a handler for the modeName mode exists) {
// instantiate the modeName handler class installed
String handler= getModeClassName (modeName)
Class C = Class.forName(handler);
modality = (ModeInterface) c.newInstance ( );

}

}

| | |
|---|---|
| modality.enable ( ); | |
| modality.addListener(this); | //assuming this implements |
| | //InputListenerInterface/java |
| } | |

For each of the rest of existing modalities {

modality.disable( );

}
In order to carry out step S12, the input controller 210
implements, in this embodiment, an input listener
interface which may be:
public interface InputListenerInterface {

void setInputResult (InputResultInterface result);

}

When an input of a particular modality is received, then the input controller 210 will be alerted to the modality input by, in this example, the appropriate modality input module or handler calling the set input result function of the input controller 210 in response to which the input controller 210 supplies the input provided by the input modality module to the operations manager 20 for further processing as described above.

In the above described embodiments, the applications developer can define in a multi-modal mark-up language document, the input mode or modes (modalities) available for use with that application and can make available for access by the user a modality module for any of the modalities specified by him so that it is not necessary for the applications developer to have any knowledge of the modality modules that a user's computing apparatus may have available. Thus, in the above described embodiment, the multi-modal mark-up language enables the applications developer to specify the use of modalities that may be specific to a particular application or are non-standard because the operations manager 20 does not need to have any information regarding the actual modality. All that is required is that the operations manager 20 can extract from the marked up documents provided by the applications developer the data necessary to obtain and install a modality input module having a handler capable of handling input in that modality. This means that the applications developer does not need to confine himself to the modalities pre-defined by the multi-modal input manager but can define or specify the facility to use one or more modalities that may be unknown to the multi-modal input manager, so enabling the applications developer to provide the user with the option to use the input modalities that are best suited to the application.

In the above described embodiments, the applications developer, that is the developer of the multi-modal mark-up language file, needs to specify the input modalities that can be used. This means that the developer has to decide upon the modalities that he wishes the user to have available.

A modification of the embodiments described above enables the applications developer to specify an input mode or modality more abstractly or functionally in his multi-modal mark-up language document file by specifying that the attribute data provided by the corresponding module of the interface manager 21 meet certain requirements (for example that the attribute data specifies a certain type of input such as pointing, position or text and/or a confidence level or precision such as “certain” or “low”) rather than actual mode or modes so that the applications developer does not have to concern himself with the input modalities that the user has available.

As an example, where the mark-up language document file includes a field for selecting a current focus in a current window displayed by the display, then the developer does not need to specify each particular input modality that enables focus to be determined (for example, cursor, gaze and so on), but may simply specify that an input mode having the attribute type “pointing” is required. Thus, instead of using the tag:

<fieldname=“focus” modes=“gaze, pointing device . . . ”</field>

which requires the use of a gaze modality input or a pointing device input,

the applications developer may include within the document the following tag:

<fieldname=“focus” modes-type=“pointing”>. . . . . . </field>which specifies that the input mode must have a type “pointing”

Thus the applications developer does not have to specify that input is required from the pointing device or gaze input modality module but rather simply specifies that a “pointing” type of input is required.

Other examples of types of input that may be specified by the developer are, for example, “position”, requiring an input that defines a position on the screen, “text” requiring an input representing text (that may be provided by a speech input or keyboard input, for example) and so on.

As mentioned above, the multi-modal mark-up language may also enable a confidence or precision for the input to be specified, for example, the confidence may be “certain” or “low” or “approximate”, so enabling the applications developer to specify how precise or certain he wishes the input to be without having to decide upon the particular modality or modalities to be used.

For example, the multi-modal mark-up language file may specify:

<input modetype=“position” confidence=“certain”>. . . . </input>

where the ellipsis again indicate that matter (such as prompts, grammars, etc) that may be placed there has been omitted.

FIG. 7 shows a flow chart illustrating steps carried out by the input controller 210 when the multi-modal mark-up language is provided with the facility to specify attributes. Thus, at step S20, the input controller 210 determines from an input element of a multi-modal mark-up language document any type and confidence level specified for that input and then, at step S21, for each available input modality module, compares the attributes of that input modality module with the specified type and confidence level and, at step S22, activates the input modality modules providing the specified type and confidence level and deactivates the rest.

This may be achieved by the input controller 210 implementing the following:

(for each of the modalities) {

modality.disable ( );
ModeProperty property=modality.queryProperty( );
for each of desired mode type) {

if (property.isType(type)) {
(for each of desired confidence level) {

if (property.isConfidenceLevel (level) {

modality.enable ( );

}

}

}

}
}

Allowing the applications developer to specify the type and possibly also a confidence level for the input without having to select the specific modality input(s) required, means that the selection of the actual modality inputs that can be used for a particular input element can be determined by the multi-modal input manager 21, on the basis of the attribute data provided by available modality input modules. For example if the multi-modal mark-up language document specifies a mode type “position” and a confidence level “certain”, then the input controller 210 will select the input modalities which the attribute data provided by the input modality modules indicates provide position information (for example, the pointing device and gaze modality inputs, shown as Xmode in FIG. 4), and will activate only those providing the required precision. For example, if the user input interface 3 includes as pointing devices both a mouse and a digitizing tablet and only the attribute data for the digitizing tablet indicates the required precision, then the input controller 210 may activate the digitizing tablet input module and deactivate the mouse input module, allowing user input from the digitising tablet but not the mouse.

Providing the applications developer with the facility to specify the type and confidence level of input required means that the user of the processor-controlled apparatus can use whatever input modalities are available that satisfy the type and confidence requirements set by the developer. Thus, for example, where the processor-controlled apparatus has an additional input modality available such as, for example, gesture, then the user will have the ability to use this input modality if it meets the required confidence level for specifying position, even though the application developer was not aware that this input modality was available.

As described above, the dialogue manager may register event listeners to listen for events. As another possibility, as shown in FIG. 4, the multi-modal input manager may include an event input module 211. Where this is provided, then multi-modal mark-up language allows the developer to handle an occurrence of type event as if it is an input from the user. To take an example, in an on-line shopping scenario, the dialogue file may be expecting an input giving the user's credit card number to complete a purchase and may specify in addition to input modes “speech” and “keypad” (or keyboard) or an attribute type “text”, an event relating to the retrieval of the card number by a software agent associated with the application, for example, the multi-modal mark-up language file may contain:

<fieldname=“Card_num modes=“speech, keypad, event $ com.myCompany.agent.cardNum”>. . . . . . </field>

In this dialogue state, the dialogue manager is expecting the user to say or key in his card number but is also ready to receive the card number from an agent that runs in parallel. In this case, the event (ie receipt of the card number from an agent) may be provided as a JAVA event object including public strings defining information regarding the event.

Other types of event such as those discussed above may also be defined as inputs.

Handling an event as if it is an input from the user rather than as an interrupting signal, for example, a <catch>element means that the normal dialogue flow is not interrupted by the arrival of the event.

It will of course be appreciated that different documents may specify different input modes or modalities or attributes or define as inputs different events and may also specify any combination of these, depending upon the particular functions required by the document.

In the above described embodiments, the ASR engine and grammar files are provided in the control apparatus. This need not necessarily be the case and, for example, the operations manager 20 may be configured to access an ASR engine and grammar files over the network N.

As described above, the processor-controlled apparatus is coupled to a network. This need not necessarily be the case and, for example, the system may be a stand alone computer apparatus where applications are downloaded and installed from a removable medium. In this case, the installed application will provide the document server supplying multi-modal mark-up language documents at the request of the dialogue interpreter.

Also, the processor-controlled apparatus need not necessarily be computing apparatus such as a personal computer but could be an item of office equipment such as photocopier, fax machine, or an item of home equipment such as, for example, a video cassette recorder (VCR), digital versatile disc (DVD) player, or any other processor-controlled apparatus that has a user interface that allows a dialogue with the user.

The above described embodiments are implemented using an extension of VoiceXML. It may also be possible to implement the present invention by extensions of other voice based mark-up languages such as VoxML. Although it is extremely advantageous for one of the modalities to be a voice or speech modality, the present invention may also be applied where a speech modality is not available, in which case the ASR engine will be omitted and the grammar file store 25b will not store any grammar files required for speech recognition.

In the above described embodiments, the modes or modalities are input modes. The present invention may also be applied where the modes or modalities are output modes. FIG. 8 shows a functional block diagram similar to FIG. 4 in which the control apparatus has a multi-modal output interface manager 22′ having an output controller 220 and respective output modules 221, 222, 223 and 224 for printer, display, speech and X-mode output modalities. These modules will be analogous to the input modality modules described above.

The provision of a multi-modal output interface manager analogous to the multi-modal input interface manager enables the applications developer to specify in the mark-up language document or dialogue files a specific type of output mode so that the applications developer can control how the control apparatus communicates with the user. In addition, the applications developer may define an output mode specific to the application that requires, for example, a particular format of spoken, displayed or printer output. As in the case of the X-mode input, the applications developer does not need to confirm him or herself with whether or not this X-mode output modality is available at the user's control apparatus because this can be downloaded by the control apparatus in a manner analogous to that described above with reference to FIG. 5.

In addition, the applications developer may specify a type and confidence level of output so that, in a manner analogous to that described above with reference to FIG. 7, the output controller 220 can select the output mode that provides the required type and/or confidence level. Thus, for example, where the applications developer specifies a text mode output with a confidence level “persistent” (that is a permanent or long lasting record is produced) as opposed to “ephemeral” (that is no permanent or long lasting record is produced) then the output controller 220 may enable the display output module 222 and possibly also the printer output module 221 but disable the speech output module 223.

In one aspect the present invention provides a processor-controlled apparatus that, when a new modality is required by an application being run by the operating environment, enables a modality module for processing data in that modality to be plugged-in, for example by being downloaded over a network such as the Internet.

In another aspect, the present invention provides a control apparatus having a processor configured to enable an application being executed by the processor to require a particular type and/or confidence of data rather than a specific modality and to activate only modality modules providing that type and/or confidence. For example, the application may specify a modality type such as “text”, “position” and, so on and in the case of the modality type “text”, the processor will activate modality modules configured to handle keyboard and voice input while for the modality type “position”, the processor will activate input modality modules configured to handle pointing device data.

In one aspect the present invention provides control apparatus having a processor configured to enable an event to be handled as if it is an input from a user.

The use of a mark-up language is particularly appropriate for conducting dialogues with the user because the dialogue is concerned with presentation (be it oral or visual) of information to the user. In such circumstances, adding mark-up to the data is much easier than writing a program to process data because, for example, it is not necessary for the applications developer to think of how records are to become configured, read or stored or how individual fields are to be addressed. Rather, everything is placed directly before them and the mark-up can be inserted into the data exactly where required. Also, mark-up languages are very easy to learn and can be applied almost instantaneously and marked up documents are easy to understand and modify.

1. Control apparatus for enabling a user to communicate with a processor-controlled apparatus using user interface means the apparatus comprising:
user interface management means having at least one interface module adapted to receive data for a corresponding user interface mode;
dialogue conducting means for conducting a dialogue with the user in accordance with mark-up language document files;
mark-up language document file supplying means for supplying at least one mark-up language document file to the dialogue conducting means during the course of a dialogue with the user;
mode determining means for determining any user interface mode or modes specified by a mark-up language document file supplied to the dialogue conducting means;
interface module determining means for determining whether the user interface management means has an interface module for the or each user interface mode specified by the mark-up language document file supplied to the dialogue conducting means; and
interface module obtaining means for, when the interface module determining means determines that the user interface management means does not have an interface module for an interface mode, obtaining an interface module for that interface mode.

2. Control apparatus according to claim 1, wherein the interface module obtaining means comprises communication means for establishing communication with a source for the interface module over a network; and downloading means for downloading the interface module via the network.

3. Control apparatus according to claim 1, wherein the interface module obtaining means comprises prompt means for advising the user that an interface module specified by a mark-up language document file is obtainable from an interface module store; communication means for establishing communication with the interface module store over a network in accordance with user instructions to obtain the interface module; and downloading means for downloading the interface module from the interface module store.

4. Control apparatus according to claim 1, wherein the control apparatus has communication means for establishing communication with a mark-up language document file provider arranged to provide at least one mark-up language document file that specifies at least one user interface mode; mark-up language document file obtaining means for obtaining a mark-up language document file from the mark-up language document file provider when communication with the mark-up language document file provider is established, the mark-up language document file supplying means being operable to supply to the dialogue conducting means a mark-up language document file obtained by the mark-up language document file obtaining means.

5. Control apparatus according to claim 4, wherein the interface module obtaining means comprises prompt means for advising the user that a mark-up language document file obtained from the mark-up language document file provider specifies an interface mode for which the interface management means does not have an interface module; communication means for establishing communication with an interface module store identified by the mark-up language document file provider over a network in accordance with user instructions to obtain the interface module; and downloading means for downloading the interface module from the interface module store.

6. Control apparatus according to claim 1, wherein a mark-up language document file specifying a user interface mode has an interface mode tag specifying the interface mode or modes.

7. Control apparatus according to claim 1, wherein a mark-up language document file specifying at least one user interface mode specifies at least one of any one of the following user interface modes: keyboard, pointing device, speech.

8. Control apparatus according to claim 1, wherein a mark-up language document file specifying at least one user interface mode specifies an interface mode specific to the application of which the mark-up language document file forms a part.

9. Control apparatus for enabling a user to communicate with a processor-controlled apparatus using user interface means, the apparatus comprising:
user interface management means having at least one interface module adapted to receive data for a corresponding user interface mode, the or each interface module providing attribute data regarding at least one attribute of the corresponding interface mode;
dialogue conducting means for conducting a dialogue with the user in accordance with mark-up language document files;
mark-up language document file supplying means for supplying different mark-up language document files to the dialogue conducting means during the course of a dialogue with the user;
attribute determining means for determining any user interface attribute specified by a mark-up language document file supplied to the dialogue conducting means;
interface module selecting means for selecting the interface module or modules providing attribute data for the attribute or attributes specified by an mark-up language document file supplied to the dialogue conducting means, thereby enabling use as an interface mode any user interface mode having the attribute or attributes specified by the mark-up language document file supplied to the dialogue conducting means.

10. Control apparatus according to claim 9, wherein the control apparatus has communication means for establishing communication with a mark-up language document file provider arranged to provide at least one mark-up language document file that specifies at least one attribute; and mark-up language document file obtaining means for obtaining a mark-up language document file from the mark-up language document file provider when communication with the mark-up language document file provider is established, the mark-up language document file supplying means being operable to supply to the dialogue conducting means mark-up language documents obtained by the mark-up language document file obtaining means.

11. Control apparatus according to claim 9, wherein a mark-up language document file specifying an attribute has an interface mode type tag specifying the attribute or attributes.

12. Control apparatus according to claim 9, wherein a mark-up language document file specifies for at least one attribute at least one of mode type and confidence.

13. Control apparatus according to claim 9, wherein a mark-up language document file specifies for at least one attribute a mode type selected from pointing, position and text.

14. Control apparatus according to claim 9, wherein a mark-up language document file specifies for at least one attribute a degree of confidence or precision required for the input.

15. Control apparatus for enabling a user to communicate with a processor-controlled apparatus using user interface means, the apparatus comprising:
user interface management means having at least one interface module adapted to receive data for a corresponding one of the user interface mode;
dialogue conducting means for conducting a dialogue with the user in accordance with mark-up language document files;
mark-up language document file supplying means for supplying different mark-up language document files to the dialogue conducting means during the course of a dialogue with the user;
interface mode determining means for determining any user interface mode or modes specified by a mark-up language document file supplied to the dialogue conducting means;
interface module activating means for activating the interface module for the or each user interface mode specified by the mark-up language document file supplied to the dialogue conducting means, wherein the user interface management means is configured to provide an event interface module and at least one mark-up language document file defines a type of event that may occur in the control apparatus or apparatus coupled thereto as an interface mode.

16. Control apparatus according to claim 1, wherein the user interface management means has an interface module for at least one of the following user interface modes:
keyboard, pointing device, speech.

17. Control apparatus according to claim 1, wherein the apparatus is configured to operate in accordance with the JAVA operating platform.

18. Control apparatus according to claim 1, wherein the mark-up language document files use a mark-up language based on XML.

19. Control apparatus according to claim 18, wherein the mark-up language document files use a mark-up language based on VoiceXML.

20. A user interface apparatus comprising a control apparatus according to claim 1 and a user interface for enabling a user to interface with the control apparatus.

21. A method of operating control apparatus for enabling a user to communicate with a processor-controlled apparatus using a user interface, the apparatus having a user interface manager having at least one interface module adapted to receive data for a corresponding user interface mode, and a dialogue conductor that conducts a dialogue with the user in accordance with mark-up language document files, the method comprising a processor of the control apparatus:
supplying means for supplying different mark-up language document files to the dialogue conductor during the course of a dialogue with the user;
determining any user interface mode or modes specified by a mark-up language document file supplied to the dialogue conductor;
determining whether the user interface manager has an interface module for the or each user interface mode specified by the mark-up language document file supplied to the dialogue conductor; and
when it is determined that the user interface manager does not have an interface module for an interface mode, obtaining an interface module for that interface mode.

22. A method of operating control apparatus for enabling a user to communicate with a processor-controlled apparatus using a user interface, the apparatus having a user interface manager means having at least one interface module adapted to receive data for a corresponding user interface mode, each interface module providing attribute data regarding at least one attribute of the corresponding interface mode, and a dialogue conductor that conducts a dialogue with the user in accordance with mark-up language document files, the method comprising a processor of the control apparatus:
supplying means for supplying different mark-up language document files to the dialogue conductor during the course of a dialogue with the user;
determining any user interface attribute specified by a mark-up language document file supplied to the dialogue conductor; and
selecting the interface module or modules providing attribute data for the attribute or attributes specified by a mark-up language document file supplied to the dialogue conductor, thereby enabling the user to use as an interface mode any user interface mode having the attribute or attributes specified by the mark-up language document file supplied to the dialogue conductor.

23. A method of operating control apparatus for enabling a user to communicate with a processor-controlled apparatus using a user interface, the apparatus having a user interface manager having at least one interface module adapted to receive data for a corresponding user interface mode and an event interface mode, and a dialogue conductor that conducts a dialogue with the user in accordance with mark-up language document files, the method comprising a processor of the control apparatus:
supplying different mark-up language document files to the dialogue conductor during the course of a dialogue with the user;
determining any user interface mode or modes specified by a mark-up language document file supplied to the dialogue conductor;
activating the interface module for the or each user interface mode specified by the mark-up language document file supplied to the dialogue conductor; and
treating an event that may occur in the control apparatus or apparatus coupled thereto as an interface mode when a mark-up language document file defines a type of event as an interface mode.

24. A signal carrying processor implementable instructions for causing a processor to carry out a method in accordance with claim 21.

25. A storage medium storing processor implementable instructions for causing a processor to carry out a method in accordance with claim 21.

26. A signal comprising a mark-up language document file for use in apparatus in accordance with claim 1, the document file specifying at least one user interface mode.

27. A signal comprising a mark-up language document specifying at least one user interface attribute for use in apparatus in accordance with claim 9.

28. A signal comprising a mark-up language document file that defines an event that may occur as an interface mode, for use in apparatus in accordance with claim 15.

29. A storage medium storing a signal in accordance with claim 26.
